(19) United States
(12) Patent Application Publication
(10) Pub. No.: US 2007/0070807 A1
(43) Pub. Date: Mar. 29, 2007

(54) Process to upgrade kerosenes and a gasoils from naphthenic and aromatic crude petroleum sources

(76) Inventors: Maarten Bracht, Amsterdam (NL); Mathijs Joseph Caanen, Amsterdam (NL); Kelvin John Hendrie, Amsterdam (NL); Sander Kaart, Amsterdam (NL); Jurjen Wietze Van Der Meer, Amsterdam (NL); Benedict Ignatius Maria Ten Bosch, Amsterdam (NL)

Correspondence Address: SHELL OIL COMPANY, P O BOX 2463, HOUSTON, TX, 772522463, US

(21) Appl. No.: 10/557,615

(22) PCT Filed: May 17, 2004
(86) PCT No.: PCT/EP04/50821

§ 371 Date: Dec. 6, 2006

(30) Foreign Application Priority Data
May 19, 2003 (EP) 03253123.8

(51) Int. Cl. B01F 5/06

(52) U.S. Cl. 366/340

(57) ABSTRACT

The invention relates to a mixing device for the homogenization of temperatures and/or concentrations in a fluid flow, having a hollow element, for conducting the fluid flow, which hollow element has: (a) a first insert positioned within the hollow element and defining an excentric passage; (b) a second insert positioned within the hollow element upstream of the first insert, wherein the second insert has a central opening; (c) a third insert positioned in the hollow element downstream of the first insert and the second insert, which third insert has at least two openings, which are evenly distributed along a concentric circle within said third insert; and (d) a fourth insert positioned in the hollow element between the first insert and the third insert, wherein the fourth insert has at least two radially extending first deflectors. The invention further relates to a module to be used in such mixing device, to an apparatus for forming syngas having such mixing device connected to a quench, and to a power generator having a fuel cell and such apparatus.

The invention relates to a mixing device for the homogenisation of temperatures and/or concentrations in a fluid flow, to a module to be used in such mixing device, to an apparatus for forming syngas comprising such mixing device connected to a quench, and to a power generator comprising a fuel cell and such apparatus.

U.S. Pat. No. 6,000,841 discloses a static mixer comprising a longitudinally elongated conduit and a central body and tabs positioned within the conduit, wherein the tabs are extending radially and inwardly from the conduit wall. The tabs redirect the longitudinal fluid flow in a radial direction. In addition, a pair of tip vortices are generated in the fluid flow that has passed the tabs. As a result, the fluid flow is mixed in the section of the conduit that extends downstream of the tabs and the central body. This mixer has a very large axial dimension in relation to its overall cross dimension.

U.S. Pat. No. 4,313,680 discloses a reactor for mixing fluid components at relatively low flow rates. The reactor comprises a reaction chamber containing a plurality of spaced-apart, flow-converting members for directing the flow of fluid components along the central axis of the reaction chamber. These flow-converting members comprise a central opening. The reactor further includes a flow-directing element arranged downstream of each flow-converging member to divide and direct the body of fluid flow at right angels from the central axis of the reaction chamber. These flow-directing elements define and excentric passage in the reaction chamber. This reactor also has a very large axial dimension in relation to its overall cross dimension.

US 2003/0007419 discloses a fluid flow translocator device for dispersing temperature gradients found in laminar flow through heat exchangers and reactors. The flow translocator comprises a conduit and includes a disk disposed transverse the length of the conduit and having an outer profile conforming to the inner profile of the conduit to form a sealed fit. Arrays of slots extend about the disk for simultaneously directing the fluid core to the inner profile of the conduit and the outer perimeter flow toward the fluid core. The slots are staggered to maintain separation of the fluid core and the outer perimeter fluid during translocation.

The object of the present invention is to improve the prior art mixers. More specifically, the object of the present invention is to provide a relatively compact mixing device.

Accordingly, the invention relates to a mixing device (6) for the homogenisation of temperatures and/or concentrations in a fluid flow, comprising a hollow element (9), for conducting said fluid flow, which hollow element (9) comprises:

(a) a first insert (11) positioned within said hollow element (9) and defining an excentric passage (12);

(b) a second insert (13) positioned within said hollow element (9) upstream of the first insert, wherein said second insert (13) comprises a central opening (14);

(c) a third insert (16) positioned in the hollow element (9) downstream of said first insert (11) and said second insert (13), which third insert (16) comprises at least two openings (17), which are evenly distributed along a concentric circle within said third insert (16); and

(d) a fourth insert (19) positioned in said hollow element (9) between said first insert (11) and said third insert (16), wherein said fourth insert (19) comprises at least two radially extending first deflectors (20).

The combination of the first insert defining an excentric passage and the second insert having an central opening enables the construction of a relatively compact mixing device, as the fluid can be mixed by radial deflection between the first and second insert. In addition, eddies may be generated along the periphery of the first insert and the periphery of the central opening in the second insert, which further improves the mixing of the fluid flow passing the inserts.

It is preferred that the area of the central opening is in the range of 50 to 150%, preferably 80 to 120% of the effective area of the excentric passage, and/or it is preferred that the second insert is positioned such that a radial passage for the fluid flow is formed between the first insert and the second insert, wherein the effective area of the radial passage, measured along the periphery of the central opening within the second insert, is in the range of 50 to 150%, preferably 80 to 120% of the area of the excentric passage. As a result, pressure losses within the fluid flow passing the first and second insert will be relatively low.

According to the invention, the second insert is located upstream of the first insert. This leads to a mixing device wherein the fluid flow is mixed due to the stepwise reduction of the typical distance over which temperature and concentration differences within the fluid flow exists. This stepwise reduction of the typical distance occurs at the central opening of the first insert, at the radial passage between the first and second insert, and at the excentric passage respectively.

The mixing device according to the invention also comprises a third insert positioned in the hollow element downstream of the first insert and the second insert, which third insert comprises at least two openings, which are evenly distributed along a concentric circle within the third insert. The fluid flow passing the third insert is mixed due to a redistribution within the fluid flow by the at least two openings, as the fluid flow is subdivided by the at least two openings in the third insert and subsequently recombined after passing the at least two openings in the third insert.

It is preferred that at least two of the openings in the third insert are provided with deflectors which have preferably the same outlines as the openings in the third insert, and which deflectors are extending radially from the third insert. This deflector further improves the redistribution within the fluid flow, and the provided deflectors may advantageously be manufactured from the plate of which the insert is manufactured itself, for example by means of laser cutting of the outline of the deflectors and by subsequently positioning of the deflectors by bending.

The mixing device according to the invention also comprises a fourth insert positioned in the hollow element between the first insert and the third insert, wherein the fourth insert comprises at least two radially extending first deflectors. Preferably, the fourth insert further comprises at least two radially extending second deflectors which are steeper than the at least two first deflectors of the fourth insert. Most preferably, the at least two first deflectors within the fourth insert are in register with the at least two openings in the third-deflector. The fourth insert advantageously leads to a redistribution within the fluid flow between the first insert and the third insert of the mixing device, as the fourth insert subdivides the fluid flow in substantially separate flows which are mutually shifted in tangential direction and subsequently partially recombined at the openings in the third insert. Moreover, the lengths of the substantially separate flows between the inclined deflectors may be different from each other along the edges of the deflectors of the fourth insert, which leads to an improved shuffling of the substantially separate flows within the fluid flow.

The invention further pertains to a module for use in the mixing device according to the invention, comprising the four inserts as hereinbefore defined and a framework, such as a set of strips, wherein the inserts are fixed in the framework. In this manner, the module may be manufactured separately from the hollow element. It is preferred to wind an isolating blanket around the module before placing it within the hollow element.

The above-mentioned and other aspects and advantages of the invention will be apparent from the following description with reference to the drawings, which schematically show a preferred embodiment of the invention, and wherein:

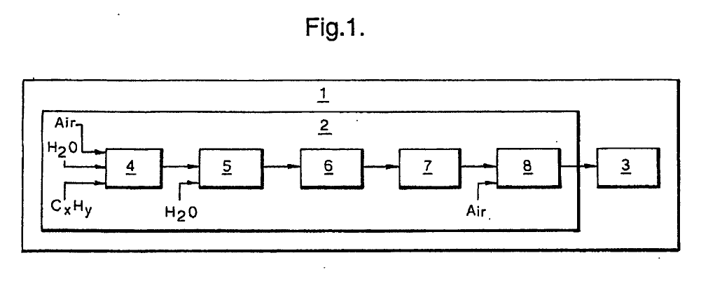

FIG. 1 is a scheme of a set up of a power generator in which a mixing device according to the invention may be incorporated;

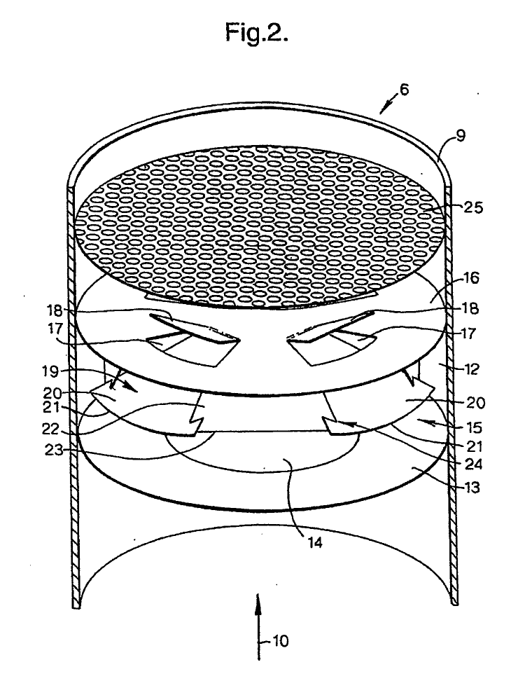

FIG. 2 is a sectional view of a preferred embodiment of the mixing device according to the invention;

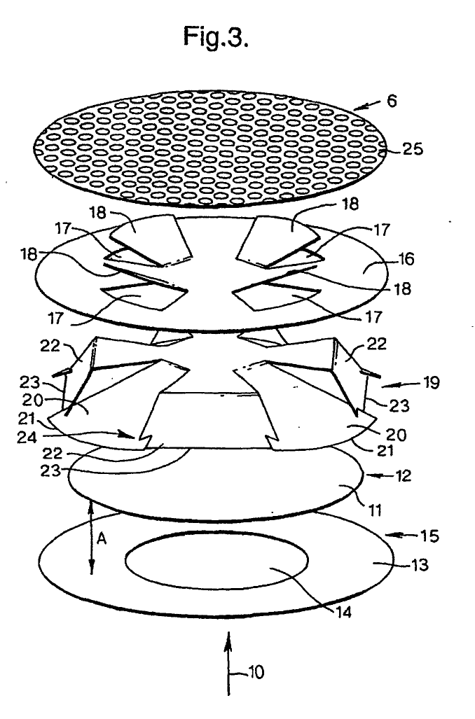

FIG. 3 is an exploded view of the mixing device of FIG. 2.

Hereinafter, a brief explanation is given of a general set up of a power generator in which the mixing device according to the invention may advantageously be incorporated, followed by a description of the parts of a preferred embodiment and a detailed description of the mixing process within the preferred embodiment of the mixing device according to the invention.

The mixing device according to the invention is intended for the homogenisation of temperatures and/or concentrations in a fluid flow, for example so-called syngas comprising vaporized water. The mixing device according to the invention may advantageously be incorporated in a power generator as schematically shown in FIG. 1, wherein hydrocarbons (CxHy) are processed. The processing of hydrocarbons results in electrical power and the generation of heat. This type of power generators may be applied in buildings to provide the electric main or backup power and to provide heat for the central heating system of the building.

The power generator may also be applied in electrically driven vehicles, for example cars, wherein the electric power is used to drive the electric main engine of the vehicle. Due to the fact that the necessary electric power demand of commercially available cars is high and the available space in the car for the power generator is limited, there is a need for compact power generators having compact components with high capacities. One of these components is a mixing device, to which this invention relates.

A power generator 1 as mentioned above is schematically shown in FIG. 1. This type of power generators generally comprises two parts, namely a fuel processor 2 wherein hydrocarbons are converted to hydrogen, and a fuel cell 3 wherein electricity is produced by electrochemical oxidation of the produced hydrogen.

The fuel processor 2 comprises a sequence of coupled components, which are generally a catalyst partial oxidator 4, a quench 5, a mixing device 6, a water gas shift section 7 and a preferential oxidator 8 respectively. During processing, the catalyst partial oxidator 4 produces hot syngas. In order to enable further processing, the hot syngas, produced by the catalyst partial oxidator 4, needs to be cooled by and mixed with vaporized water (H₂O), i.e. the water is injected in the hot syngas flow and vaporized by the quench, and subsequently mixed by mixing device 6.

One preferred embodiment of the mixing device 6 is shown in FIGS. 2 and 3. According to FIG. 2, the mixing device 6 comprises a hollow element such as a round tube 9 for conducting a fluid flow in a preferred direction as indicated by an arrow 10.

With reference to FIGS. 2 and 3, the preferred embodiment of the mixing device 6 comprises a first insert 11 positioned within the tube 9 and having a circular periphery. The first insert 11 is made by laser cutting for example. As the outer diameter of the insert 11 is smaller than the inner diameter of tube 9, an excentric passage 12 having an effective area for the passage of the fluid flow is defined between the first insert 11 and the inner wall of the tube 9. The excentric passage 12 may also be defined in any other way, for example by means of a plate having multiple openings along its periphery.

As shown in FIGS. 2 and 3, the preferred embodiment of the mixing device 6 further comprises a second insert 13 positioned within the tube 9 and upstream of the first insert 11. This second insert 13 comprises a central opening 14. Both the second insert 13 and the central opening 14 in the second insert 13 may have a circular periphery, and the second insert 13 is fixed to the inner wall of tube 9, for example by welding. The central opening 14 defines a passage for the fluid flow. As the first insert 11 and second insert 13 are substantially flat and positioned substantially parallel to each other at a particular distance A relative to each other, a radial passage 15 having an effective area for the fluid flow is formed between the first insert 11 and second is insert 13. Herein the effective area of the radial passage 15 is defined perpendicular to the radial fluid flow. In this embodiment, the area of the central opening 14 in the first insert 11, and the effective area of the excentric passage 12, and the area of the radial passage 15 measured along the periphery of the central opening 14 in the second insert 13 are substantially equal to each other.

As shown in FIGS. 2 and 3, the preferred embodiment of the mixing device 6 further comprises a third insert 16 positioned in the tube 9, at a downstream position of the first insert 11 and the second insert 13 and parallel thereto. This third insert 16 may advantageously be circular and comprises four openings 17 which are evenly distributed along a concentric circle within the third insert 16. The sum of the areas of the four openings 17 is two-third of the area of the central opening 14 in the third insert 16. The third insert 16 is made by laser cutting for example and is fixed to the inner wall of tube 2, for example by welding. The openings 17 in the third insert 16 are provided with radially extending deflectors 18 having the same outlines as the openings 17 in the third insert 16. The deflectors 18 may advantageously be manufactured from the same flat plate of which the third insert 16 is made, for example by laser cutting the outline of the deflectors 18 except for their innermost edges. The deflectors 18 are subsequently bend about the edges to their deflected position as shown in FIGS. 2 and 3.

Referring to FIGS. 2 and 3, the preferred embodiment of the mixing device further comprises a fourth insert 19 positioned within the tube 9 between the first insert 11 and third insert 16, and substantially parallel thereto. This fourth insert 19 comprises four radially extending first deflectors 20 each having an outer extending edge 21 and four radially extending second deflectors 22 each having an outer extending edge 23. The first deflectors 20 and the second deflectors 22 of the fourth insert 19 are staggered and adjacent to each other. In this embodiment, the second deflectors 22 are steeper than the first deflectors 20. In addition, the outer extending edges 21 of the first deflectors 20 extend in radial direction with regard to the outer extending edges 23 of the second inserts 22. The staggered first deflectors 20 and second deflectors 22 of the fourth insert 19 are kept in position with respect to each other by means of plug-and-socket connections 24 along the adjacent edges of the deflectors. The fourth insert 19 is designed such, that the fourth insert 19 may be formed out of one flat plate by means of laser cutting for example. Hereby the outlines of the first deflectors 20 and the second deflectors 22, as well as the outlines of the slots of the plug-and-socket connections 24 may be cut within the same cutting cycle during manufacturing of the fourth insert 19. After cutting, the first deflectors 20 and the second deflectors 22 are formed by means of bending and by plugging of the plug-and-socket connections 24. The first insert 11 is advantageously fixed to the second deflectors 22 of the fourth insert 19 along the outer extending edges 23 of the second deflectors 22 of the fourth insert 19, for example by welding. In addition, the outer extending edges 21 of the first deflectors 20 of the fourth insert 19 coincide with the inner wall of the tube 9 and are therefore fixed to the inner wall of the tube 9, for example by welding. As the outer extending edges 23 of the second deflectors 22 of the fourth insert 19 coincides with the periphery of the first insert 11, and as the outer extending edges 23 of the second inserts 22 of the fourth insert 19 coincide with the inner wall of the tube 9, the excentric passage 12 defined by the first insert 11 is subdivided into eight axial sub-passages downstream of the first insert 11. In addition, the fourth insert 19 is positioned such, that the first deflectors 20 of the fourth inserts are in register with the four openings 17 in the third insert 16.

With reference to FIGS. 2 and 3, the preferred embodiment of the mixing device 6 further comprises a perforated plate 25, which is positioned downstream of the third insert 16. This perforated plate 25 is advantageously fixed to the inner wall of the tube 9, for example by welding. The typical open area of the perforated plate may be 25%.

In operation, the mixing process within the preferred embodiment is as follows:

A fluid flow is conducted by the tube 9 in the direction as indicated by arrow 10 in FIGS. 2 and 3. The fluid flow subsequently passes the central opening 14 in the first insert 11, the radial passage 15 area between the first insert 11 and the second insert 13, the excentric passage 12 defined by the first insert 11, the first deflectors 20 and/or second deflectors 22 of the fourth insert 19, the openings 17 in the fourth insert 19, the deflectors 18 at the third insert 16, and the perforated plate 25.

The fluid flow passing the first insert 11 and the second insert 13 is mixed by the radial deflection of the fluid flow between the first insert 11 and second insert 13, as well as by the generation of eddies in the fluid flow along the periphery of the first insert 11 and along the periphery of the central opening 14 in the second insert 13, as well as by the subsequent stepwise reductions of the typical distance over which temperatures and concentration differences exists. This stepwise reductions of the typical distance occurs at the central opening 14 of the first insert 11, at the radial passage 15 area between the first insert 11 and the second insert 13, and at the excentric passage 12 defined by the first insert 11 respectively. In this preferred embodiment the area of the central opening 14 in the first insert 11, and the effective area of the excentric passage 12, and the effective area of the radial passage 15 measured along the periphery of the central opening 14 in the second insert 13 are substantially equal to each other. As a result, pressure losses within the fluid flow passing the first and second insert are relatively low.

After passing the first insert 11, a redistribution within the fluid flow takes place, as the fluid flow is subdivided into eight substantially separate flows by the radially extending first deflectors 20 and the second deflectors 22 of the fourth insert 19. Due to the mutually different inclinations of the first deflectors 20 and the second deflectors 22 of the fourth insert 19, and due to the position of the openings 17 with regards to the third insert 16, the substantially separate flows are mutually shifted in tangential direction and subsequently partially recombined at the openings 17 in the third insert 16. As the lengths of the substantially separate flows may be different from each other along the inclined edges of the first deflectors 20 and second deflectors 22 of the fourth insert 19, the shuffling of the substantially separate flows within the fluid flow is even further improved.

After passing the openings 17 in the third insert 16, the partially recombined fluid flows guided by the openings 17 are recombined. Moreover, the fluid flow is further redistributed by the radial deflection of the fluid flow by the radially extending deflectors 18 of the third insert 16.

Finally, the fluid flow passes the perforated plate 25 of the mixing device 6, whereby the redistribution within the fluid flow is enhanced as well.

As should be understood, the mixing device 6 according to the invention mixes a fluid flow by means of a combination radial deflection of the fluid flow, by stepwise decreases of the typical distance over which temperature and concentration in the fluid flow exists, by redistribution of substantially separate flows within the fluid flow, and by the generation of eddies.

In the described preferred embodiment of the mixing device 6, the third insert 16 comprises four openings 17 provided with four deflectors 18, and the fourth insert 19 comprises four first deflectors 20 and four second deflectors 22. Good mixing results are also obtained with two or three such groups, but four groups is preferred.

In the described preferred embodiment of the mixing device 6, the sum of the areas of the four openings 17 in the third insert 16 is two-third of the area of the central opening 14 in the second insert 13. In general it is preferred that the sum of the areas of the at least two openings in the third insert is 15 to 115%, and more preferably 45 to 85% of the area of the central opening in the second insert.

In the described preferred embodiment of the mixing device 6, the second insert 13, the third insert 16, the fourth insert 19 and the perforated plate 25 were fixed to the inner wall of the tube 9, for example by means of welding. It is also possible to fix the inserts and the perforated plate within any kind of framework, such as a set of strips or the like, whereby a module is formed. The module may be embedded within the tube 9. In order to ensure a sufficient isolation between the inserts of the module and the inner wall of the tube 9, it is preferred that the module is wrapped in an isolating blanked before placing the module in the tube.

As a matter of course, the mixing device according to the invention is not restricted to the particular embodiment shown in the drawings and described hereinbefore, but may be varied in different manners within the scope of the invention, as defined by the claims.

1. A process to prepare a kersosene and a gasoil product from a crude petroleum source having a Watson characterization factor K value of equal to or below 12.0 comprising:
(a) isolating a petroleum derived kerosene fraction and a petroleum derived gasoil fraction from said crude petroleum source, wherein the petroleum derived kerosene fraction has a smoke point of below 25 mm if the naphthalenes content of the petroleum derived kerosene fraction is at least 3% vol, or below 19 mm if the naphthalenes content of the petroleum derived kerosene fraction is below 3% vol, and the petroleum derived gasoil fraction has a cetane number of below 50 or a density higher than 845 kg/m3;
(b) adding a Fischer-Tropsch derived kerosene fraction to the petroleum derived kerosene fraction in an amount sufficient to obtain a mixture having a smoke point value of above 25 mm if the naphthalenes content of the mixture is at least 3% vol, or above 19 mm if the naphthalenes content of the mixture is below 3% vol; and,
(c) adding a Fischer-Tropsch derived gasoil fraction to the petroleum derived gasoil fraction such that the resultant mixture has a cetane number value of above 51, wherein the Fischer-Tropsch derived kerosene fraction and the Fischer-Tropsch derived gasoil fraction each have an iso-paraffins to normal paraffin weight ratio of greater than 0.3.

2. The process of claim 1, wherein the petroleum derived kerosene fraction and the petroleum derived gasoil fraction are isolated from the crude petroleum source in a hydroskimming refinery.

3. The process of claim 1, wherein the petroleum derived gasoil fraction and the petroleum derived kerosene fraction are each more than 50 wt % based on a crude having a Watson characterization factor K value equal to or below 12.0.

4. The process of claim 1, wherein the petroleum derived kerosene fraction has an ASTM D86 distillation initial boiling point of between 140° C. to 200° C. and a final boiling point of between 200° C. to 300° C.

5. The process of claim 1, wherein the petroleum derived gasoil fraction has an ASTM D86 distillation initial boiling point of between 250° C. to 300° C. and a final boiling point of between 340° C. to 380° C.

6. The process of claim 1, wherein the Fischer-Tropsch derived kerosene fraction and the Fischer-Tropsch derived gasoil fraction each have an iso-paraffin to normal paraffin weight ratio of between 2 and 6.

7. The process of claim 2, wherein the petroleum derived gasoil fraction and the petroleum derived kerosene fraction are each more than 50 wt % based on a crude having a Watson characterization factor K value equal to or below 12.0.

8. The process of claim 2, wherein the petroleum derived kerosene fraction has an ASTM D86 distillation initial boiling point of between 140° C. to 200° C. and a final boiling point of between 200° C. to 300° C.

9. The process of claim 2, wherein the petroleum derived gasoil fraction has an ASTM D86 distillation initial boiling point of between 250° C. to 300° C. and a final boiling point of between 340° C. to 380° C.

10. The process of claim 2, wherein the Fischer-Tropsch derived kerosene fraction and the Fischer-Tropsch derived gasoil fraction each have an iso-paraffin to normal paraffin weight ratio of between 2 and 6.

11. The process of claim 3, wherein the petroleum derived kerosene fraction has an ASTM D86 distillation initial boiling point of between 140° C. to 200° C. and a final boiling point of between 200° C. to 300° C.

12. The process of claim 3, wherein the petroleum derived gasoil fraction has an ASTM D86 distillation initial boiling point of between 250° C. to 300° C. and a final boiling point of between 340° C. to 380° C.

13. The process of claim 3, wherein the Fischer-Tropsch derived kerosene fraction and the Fischer-Tropsch derived gasoil fraction each have an iso-paraffin to normal paraffin weight ratio of between 2 and 6.

14. The process of claim 4, wherein the petroleum derived gasoil fraction has an ASTM D86 distillation initial boiling point of between 250° C. to 300° C. and a final boiling point of between 340° C. to 380° C.

15. The process of claim 4, wherein the Fischer-Tropsch derived kerosene fraction and the Fischer-Tropsch derived gasoil fraction each have an iso-paraffin to normal paraffin weight ratio of between 2 and 6.

16. The process of claim 5, wherein the Fischer-Tropsch derived kerosene fraction and the Fischer-Tropsch derived gasoil fraction each have an iso-paraffin to normal paraffin weight ratio of between 2 and 6.

17. A process to prepare a kerosene product from a crude petroleum source having a Watson characterization factor K value of equal to or below 12.0 comprising:
(a) isolating a petroleum derived kerosene fraction from said crude petroleum source, wherein the petroleum derived kerosene fraction has a smoke point of below 25 mm if the naphthalenes content of the petroleum derived kerosene fraction is at least 3% vol, or below 19 mm if the naphthalenes content of the kerosene fraction is below 3% vol; and,
(b) adding a Fischer-Tropsch derived kerosene fraction to the petroleum derived kerosene fraction in an amount sufficient to obtain a mixture having a smoke point value of above 25 mm if the naphthalenes content of the mixture is at least 3% vol, or above 19 mm if the naphthalenes content of the mixture is below 3% vol, wherein the Fischer-Tropsch derived kerosene fraction has an iso-paraffin to normal paraffin weight ratio of greater than 0.3.

18. The process of claim 17, wherein the petroleum derived kerosene fraction is isolated from the crude petroleum source in a hydroskimming refinery.

19. The process of claim 17, wherein the petroleum derived kerosene fraction is more than 50 wt % based on a crude having a Watson characterization factor K value equal to or below 12.0.

20. The process of claim 17, wherein the petroleum derived kerosene fraction has an ASTM D86 distillation initial boiling point of between 140° C. to 200° C. and a final boiling point of between 200° C. to 300° C.

21. The process of claim 17, wherein the Fischer-Tropsch derived kerosene fraction has an iso-paraffin to normal paraffin weight ratio of between 2 and 6.

22. A process to prepare a gasoil product from a crude petroleum source having a Watson characterization factor K value of equal to or below 12.0 comprising:
(a) isolating a petroleum derived gasoil fraction from said crude petroleum source, wherein the petroleum derived gasoil fraction has a cetane number of below 50 and/or a density higher than 845 kg/m3; and
(b) adding a Fischer-Tropsch derived gasoil fraction to the petroleum derived gasoil fraction such that the resultant mixture has a cetane number value of above 51, wherein the Fischer-Tropsch derived gasoil fraction has an iso-paraffin to normal paraffin weight ratio of greater than 0.3.

23. The process of claim 22, wherein the petroleum derived gasoil fraction is isolated from the crude petroleum source in a hydroskimming refinery.

24. The process of claim 22, wherein the petroleum derived gasoil fraction is more than 50 wt % based on a crude having a Watson characterization factor K value equal to or below 12.0.

25. The process of claim 22, wherein the petroleum derived gasoil fraction has an ASTM D86 distillation initial boiling point of between 250° C. to 300° C. and a final boiling point of between 340° C. to 380° C.

26. The process of claim 22, wherein the Fischer-Tropsch derived gasoil fraction has an iso-paraffin to normal paraffin weight ratio of between 2 and 6.

27. A process to prepare a hydrocarbon product from a crude petroleum source having a Watson characterization factor K value of equal to or below 12.0 comprising:
(a) isolating a petroleum derived kerosene fraction and a petroleum derived gasoil fraction from said crude petroleum source, wherein the petroleum derived kerosene fraction has a smoke point of below 25 mm if the naphthalenes content of the petroleum derived kerosene fraction is at least 3% vol, or below 19 mm if the naphthalenes content of the petroleum derived kerosene fraction is below 3% vol, and the petroleum derived gasoil fraction has a cetane number of below 50 and/or a density higher than 845 kg/m3; and
(b) adding a Fischer-Tropsch derived kerosene fraction to the petroleum derived kerosene fraction in an amount sufficient to obtain a mixture having a smoke point value of above 25 mm if the naphthalenes content of the mixture is at least 3% vol, or above 19 mm if the naphthalenes content of the mixture is below 3% vol; and/or,
(c) adding a Fischer-Tropsch derived gasoil fraction to the petroleum derived gasoil fraction such that the resultant mixture has a cetane number value of above 51, wherein the Fischer-Tropsch derived kerosene fraction and the Fischer-Tropsch derived gasoil fraction each have an iso-paraffin to normal paraffin weight ratio of greater than 0.3.

28. The process of claim 27, wherein the petroleum derived kerosene fraction and/or the petroleum derived gasoil fraction are isolated from the crude petroleum source in a hydroskimming refinery.

29. The process of claim 27, wherein the petroleum derived gasoil fraction and the petroleum derived kerosene fraction are each more than 50 wt % based on a crude having a Watson characterization factor K value equal to or below 12.0.

30. The process of claim 27, wherein the petroleum derived kerosene fraction has an ASTM D86 distillation initial boiling point of between 140° C. to 200° C. and a final boiling point of between 200° C. to 300° C.

31. The process of claim 27, wherein the petroleum derived gasoil fraction has an ASTM D86 distillation initial boiling point of between 250° C. to 300° C. and a final boiling point of between 340° C. to 380° C.

32. The process of claim 27, wherein the Fischer-Tropsch derived kerosene fraction and the Fischer-Tropsch derived gasoil fraction each have an iso-paraffin to normal paraffin weight ratio of between 2 and 6.

33. The process of claim 28, wherein the petroleum derived gasoil fraction and the petroleum derived kerosene fraction are each more than 50 wt % based on a crude having a Watson characterization factor K value equal to or below 12.0.

34. The process of claim 28, wherein the petroleum derived kerosene fraction has an ASTM D86 distillation initial boiling point of between 140° C. to 200° C. and a final boiling point of between 200° C. to 300° C.

35. The process of claim 28, wherein the petroleum derived gasoil fraction has an ASTM D86 distillation initial boiling point of between 250° C. to 300° C. and a final boiling point of between 340° C. to 380° C.

36. The process of claim 28, wherein the Fischer-Tropsch derived kerosene fraction and the Fischer-Tropsch derived gasoil fraction each have an iso-paraffin to normal paraffin weight ratio of between 2 and 6.
